(19) United States
(12) Patent Application Publication
(10) Pub. No.: US 2023/0227705 A1
(43) Pub. Date: Jul. 20, 2023

(54) THERMAL CONDUCTIVITY ENHANCEMENT OF NANOFLUIDS USING FUNCTIONALIZED OR EMULSIFIED CARBIDE DERIVED CARBON NANOPARTICLES

(71) Applicant: Qatar Foundation for Education, Science and Community Development, Doha (QA)

(72) Inventors: Tareq A. AL-ANSARI, Doha (QA); Ismail Walid Khalil ALMANASSRA, Doha (QA); Muataz ATIEH, Doha (QA); Viktor KOCHKODAN, Doha (QA)

(21) Appl. No.: 18/010,368

(22) PCT Filed: Jun. 15, 2021
(86) PCT No.: PCT/QA2021/050014

§ 371 Date: Dec. 14, 2022

Related U.S. Application Data
(60) Provisional application No. 63/039,157, filed on Jun. 15, 2020.

(51) Int. Cl. C09K 5/10

(52) U.S. Cl. CPC C09K 5/10; B82Y 30/00

(57) ABSTRACT

A new and innovative nanofluid is provided including carbide-derived carbon nanoparticles suspended in a base fluid, and a method of preparing the same. In one example, the inventors have demonstrated that a nanofluid including CDC nanoparticles suspended in a base fluid of water had an increased thermal conductivity as compared to water alone. In other examples, the provided nanofluid may include CDC nanoparticles suspended in a base fluid other than water, such as antifreeze mixtures or other suitable cooling or heating fluids. During preparation of the provided nanofluid, the base fluid and CDC nanoparticles mixture may be subjected to sonication. In some instances, the CDC nanoparticles may be functionalized, such as by a carboxylation process. In some instances, the CDC nanoparticles may be emulsified, such as by being mixed with a surfactant.

### PRIORITY CLAIM

The present application claims priority to and the benefit of U.S. Provisional Application 63/039,157, filed Jun. 15, 2020, the entirety of which is herein incorporated by reference.

### TECHNICAL FIELD

The present application relates generally to nanofluids. More specifically, the present application relates to the thermal conductivity enhancement of nanofluids having carbide-derived carbon nanoparticles.

### BACKGROUND

Available cooling fluids used in various heat transfer applications such as water, glycols and refrigerants have limited thermal properties. The traditional method for enhancing the heat transfer is through increasing the heat transfer area or increasing the flow rate of heat transfer fluids. Developments in modern nanotechnology have resulted in improved heat transfer performance, energy savings and reducing the environmental impact. This is achieved by infusing heat transfer fluids with highly conductive nanomaterials which are suspended in the fluids to produce what is known as a “nanofluid”. Due to the ultra-high level of energy consumption in different sectors in an era of climate change and resource security concerns, new heat transfer enhancement approaches are being applied in all industrial sectors such as transportation, electronics, chemical and petrochemical industry, power plants and the photonics industry.

Different types of nanoparticles (metallic, nonmetallic, polymeric and carbon materials) have been experimented with in order to enhance the thermal conductivity of conventional cooling and heating fluids. Carbon materials and its derivatives such as graphene, carbon nanotubes (multi wall (MWCNT), few wall (FWCNT), double wall (DWCNT) and single wall (SWCNT)), graphene oxide and nano-diamond are of interest in the field of nanofluids due to their ultra-high thermal conductivity values as compared to the polymeric, metallic and non-metallic particles. Typical thermal conductivity-enhanced nanofluids, however, have less than desired properties.

Carbon nanotubes, graphene, and graphene oxide have strong van der waals interaction forces which result in the sedimentation of nanoparticles. As such, it is challenging to obtain highly stable carbon derivatives in base fluids. Mechanical and chemical methods have typically been utilized to help stabilize nanoparticles in the base fluids. Mechanical (physical) methods can involve ultra-sonication, while chemical methods can either involve surfactants or functionalizing the surface of the nanoparticles with a chemical group by a series of chemical reactions. Using surfactants or by functionalizing the surface of nanoparticles increases the charge of particles, allowing them to repel one another thus resulting in higher stability. The use of surfactants can have undesirable effects on the thermophysical properties of nanofluids, such as increasing the viscosity and formation of foam, although surfactants have been found to enhance the stability of carbon nanotubes and other carbon materials in polar solvents for longer than six months.

### SUMMARY

The present application provides a new and innovative nanofluid having carbide-derived carbon (CDC) nanoparticles. The provided nanofluid demonstrates enhanced thermal conductivity compared to a base fluid (e.g., water) without the suspended CDC nanoparticles. For example, the inventors' experiments have shown that CDC nanoparticles increased the thermal conductivity of water with a maximum enhancement of 26% using 0.3 wt % of functionalized CDC. The CDC nanoparticles may be suspended in water or other base fluids. In some aspects, a presently disclosed method for preparing the provided nanofluid includes the carboxylation method by acid treatment for the CDC nanoparticles. Because CDC nanoparticles have low stability in polar solutions and tend to agglomerate when they are suspended without modification, the carboxylation method by acid treatment for the CDC nanoparticles can help enhance their hydrophobicity properties and increase their particle charge. In other aspects, the provided method for preparing the nanofluid includes mixing CDC nanoparticles with a surfactant to emulsify the CDC nanoparticles.

In light of the technical features set forth herein, and without limitation, in a first aspect of the disclosure in the present application, which may be combined with any other aspect unless specified otherwise, a method of preparing a nanofluid includes mixing a predetermined amount of carbide-derived carbon nanoparticles in a base fluid, thereby forming a mixture. The mixture may then be subjected to sonication for a predetermined amount of time.

In a second aspect of the disclosure in the present application, which may be combined with any other aspect (e.g., the first or thirteenth aspect) unless specified otherwise, the base fluid is water.

In a third aspect of the disclosure in the present application, which may be combined with any other aspect (e.g., the first aspect) unless specified otherwise, the method further includes functionalizing the predetermined amount of carbide-derived carbon nanoparticles prior to mixing the functionalized predetermined amount of carbide-derived carbon nanoparticles in the base fluid.

In a fourth aspect of the disclosure in the present application, which may be combined with any other aspect (e.g., the third aspect) unless specified otherwise, the predetermined amount of carbide-derived carbon nanoparticles is functionalized with a carboxylation process.

In a fifth aspect of the disclosure in the present application, which may be combined with any other aspect (e.g., the fourth aspect) unless specified otherwise, the carboxylation process includes dispersing carbide-derived carbon nanoparticle powder in an acid mixture of sulfuric acid (H₂SO₄) and phosphoric acid (H₃PO₄) thereby forming a CDC-acid mixture. The acid mixture is positioned in an ice bath and continuously stirred while the carbide-derived carbon nanoparticle powder is dispersed in the acid mixture. Potassium permanganate (KMnO₄) is then added to the CDC-acid mixture while maintaining a temperature of the CDC-acid mixture at or below 5° C. thereby forming a KMnO₄-CDC-acid mixture. The KMnO₄-CDC-acid mixture is then stirred while the KMnO₄-CDC-acid mixture is positioned in an oil bath at a temperature greater than or equal to 40° C. and less than or equal to 50° C. Deionized water is added to the KMnO₄-CDC-acid mixture while the KMnO₄-CDC-acid mixture is positioned in the ice bath. The KMnO₄-CDC-acid mixture is then stirred while the KMnO₄-CDC-acid mixture is positioned in the oil bath at a temperature greater than or equal to 80° C. and less than or equal to 85° C. Deionized water and hydrogen peroxide (H₂O₂) are added to the KMnO₄-CDC-acid mixture while the KMnO₄-CDC-acid mixture is positioned in the ice bath, thereby forming a reaction mixture.

In a sixth aspect of the disclosure in the present application, which may be combined with any other aspect (e.g., the fifth aspect) unless specified otherwise, the acid mixture has a volumetric ratio of H₂SO₄ to H₃PO₄ of 60:40.

In a seventh aspect of the disclosure in the present application, which may be combined with any other aspect (e.g., the fifth aspect) unless specified otherwise, the KMnO₄-CDC-acid mixture is stirred for 2.5 hours while positioned in the oil bath at a temperature greater than or equal to 40° C. and less than or equal to 50° C.

In an eighth aspect of the disclosure in the present application, which may be combined with any other aspect (e.g., the fifth aspect) unless specified otherwise, the KMnO₄-CDC-acid mixture is stirred for 2 hours while positioned in the oil bath at a temperature greater than or equal to 80° C. and less than or equal to 85° C.

In a ninth aspect of the disclosure in the present application, which may be combined with any other aspect (e.g., the fifth aspect) unless specified otherwise, the carboxylation process further includes washing the reaction mixture with hydrochloric acid (HCl). The reaction mixture washed with HCl is then subjected to centrifuge thereby obtaining wet oxidized carbide-derived carbon nanoparticle powder. The obtained wet oxidized carbide-derived carbon nanoparticle powder is washed and subjected to centrifuge with deionized water until a neutral suspension having a pH of 7 is obtained. The obtained neutral suspension is then dried.

In a tenth aspect of the disclosure in the present application, which may be combined with any other aspect (e.g., the first aspect) unless specified otherwise, the predetermined amount of carbide-derived carbon nanoparticles is mixed with a predetermined amount of a surfactant in the base fluid to thereby form the mixture.

In an eleventh aspect of the disclosure in the present application, which may be combined with any other aspect (e.g., the tenth aspect) unless specified otherwise, a ratio by weight of the predetermined amount of carbide-derived carbon nanoparticles to the predetermined amount of the surfactant is 1:1 or 1:2.

In a twelfth aspect of the disclosure in the present application, which may be combined with any other aspect (e.g., the tenth or sixteenth aspect) unless specified otherwise, the surfactant is gum Arabic.

In a thirteenth aspect of the disclosure in the present application, which may be combined with any other aspect unless specified otherwise, a nanofluid includes a base fluid and carbide-derived carbon nanoparticles suspended in the base fluid. The carbide-derived carbon nanoparticles are one of functionalized or emulsified.

In a fourteenth aspect of the disclosure in the present application, which may be combined with any other aspect (e.g. the thirteenth aspect) unless specified otherwise, a concentration of the carbide-derived carbon nanoparticles is greater than zero and less than or equal to 0.3% by weight of the nanofluid.

In a fifteenth aspect of the disclosure in the present application, which may be combined with any other aspect (e.g. the thirteenth aspect) unless specified otherwise, a concentration of the carbide-derived carbon nanoparticles is equal to 0.3% by weight of the nanofluid.

In a sixteenth aspect of the disclosure in the present application, which may be combined with any other aspect (e.g. the thirteenth aspect) unless specified otherwise, the nanofluid further includes a surfactant.

In a seventeenth aspect of the disclosure in the present application, which may be combined with any other aspect (e.g. the sixteenth aspect) unless specified otherwise, a ratio by weight of carbide-derived carbon nanoparticles to surfactant is 1:1.

In an eighteenth aspect of the disclosure in the present application, which may be combined with any other aspect (e.g. the sixteenth aspect) unless specified otherwise, a ratio by weight of carbide-derived carbon nanoparticles to surfactant is 1:2.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1 illustrates a flowchart of an example method of preparing a nanofluid, according to an aspect of the present disclosure.

FIGS. 2A and 2B illustrate SEM images of raw and functionalized carbide-derived carbon nanoparticles respectively, according to an aspect of the present disclosure.

FIGS. 3A and 3B illustrate TEM images of raw carbide-derived carbon nanoparticles, according to an aspect of the present disclosure.

FIGS. 4A and 4B illustrate TEM images of functionalized carbide-derived carbon nanoparticles, according to an aspect of the present disclosure.

FIGS. 5A and 5B illustrate EDS elemental analysis graphs of raw and functionalized carbide-derived carbon nanoparticles respectively, according to an aspect of the present disclosure.

FIG. 6 illustrates an FTIR spectrum graph of raw and functionalized carbide-derived carbon nanoparticles, according to an aspect of the present disclosure.

FIG. 7 illustrates a graph of Zeta potential measurements of carbide-derived carbon nanoparticles, according to an aspect of the present disclosure.

FIG. 8A illustrates carbide-derived carbon nanoparticles at preparation time, according to an aspect of the present disclosure.

FIG. 8B illustrates carbide-derived carbon nanoparticles three months after preparation time, according to an aspect of the present disclosure.

FIGS. 9A to 9C illustrate viscosity graphs for a nanofluid having 0.05 wt %, 0.1 wt %, and 0.3 wt % of carbide-derived carbon nanoparticles respectively, according to an aspect of the present disclosure.

FIG. 10 illustrates a viscosity graph for nanofluids including functionalized carbide-derived carbon nanoparticles, according to an aspect of the present disclosure.

FIG. 11 illustrates a thermal conductivity graph for nanofluids including functionalized carbide-derived carbon nanoparticles, according to an aspect of the present disclosure.

FIGS. 12A and 12B illustrate thermal conductivity graphs for nanofluids including a carbide-derived carbon nanoparticle to surfactant ratio of 1:1 and 1:2 respectively, according to an aspect of the present disclosure.

FIGS. 13A and 13B illustrate specific heat capacity graphs for nanofluids including a carbide-derived carbon nanoparticle to surfactant ratio of 1:1 and 1:2 respectively, according to an aspect of the present disclosure.

FIG. 14 illustrates a specific heat capacity graph for nanofluids including functionalized carbide-derived carbon nanoparticles, according to an aspect of the present disclosure.

### DETAILED DESCRIPTION

The present application provides a new and innovative nanofluid including carbide-derived carbon nanoparticles suspended in a base fluid, and a method of preparing the same. Carbide-derived carbon (CDC) is a carbon generation material that has a wide range of properties depending on experimental conditions. It is a nanoporous carbon derived from different precursors such as SiC, TiC, and polymer derived ceramics such as Ti—C or Si—O—C. CDC is a material with an amorphous to crystalline structure demonstrating unique properties which can include: high specific surface area, high stability, controllable pore size distribution and conductivity. While other carbon derivatives have been utilized to prepare nanofluids, typical nanofluids have not included CDC nanoparticles.

In one example, the inventors have demonstrated that a nanofluid including CDC nanoparticles suspended in a base fluid of water had an increased thermal conductivity as compared to water alone. In other examples, the provided nanofluid may include CDC nanoparticles suspended in a base fluid other than water, such as antifreeze mixtures or other suitable cooling or heating fluids. The CDC nanoparticles may be stabilized and dispersed in the base fluid through mechanical and/or chemical processes. For instance, a mechanical process may involve subjecting a mixture of the base fluid and the CDC nanoparticles to sonication. In other instances, a chemical process may involve functionalizing or emulsifying the CDC nanoparticles. For example, the provided nanofluid preparation method may include a carboxylation process to functionalize raw CDC nanoparticles prior to mixing the functionalized CDC nanoparticles with a base fluid. In another example, the provided nanofluid preparation method may include mixing raw CDC nanoparticles with a surfactant (e.g., gum Arabic) in a base fluid to emulsify the CDC nanoparticles.

The inventors' experiments have shown that a CDC-water nanofluid was stable for more than 3 months. As such, the provided nanofluid can be utilized for a variety of practical applications. In one example implementation, the provided nanofluid could replace typical cooling and heating fluids available in the market, such as water and antifreeze, due to its increased thermal conductivity compared to those typical fluids on the market. In another example implementation, the provided nanofluid could also be used as a fluid in heat transfer applications such as heat exchangers, solar collectors, and air conditioning systems.

### Method and Nanofluid Embodiments

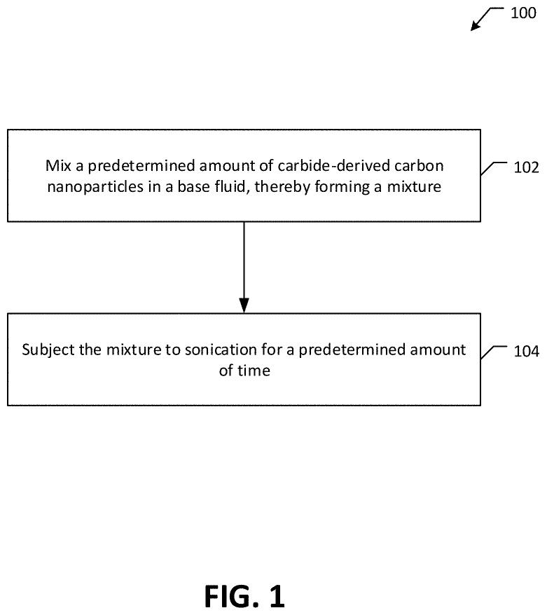

FIG. 1 shows a flow chart of an example method 100 for preparing a nanofluid. Although the example method 100 is described with reference to the flowchart illustrated in FIG. 1, it will be appreciated that many other methods of performing the acts associated with the method 100 may be used. For example, the order of some of the blocks may be changed, certain blocks may be combined with other blocks, and some of the blocks described are optional.

In various aspects of the example method 100, a predetermined amount of CDC nanoparticles may first be mixed in a base fluid, thereby forming a mixture (block 102). In some examples, the base fluid may be water. In other examples, the base fluid may be another suitable heating or cooling fluid such as an antifreeze mixture. The predetermined amount of CDC nanoparticles may be an amount of CDC nanoparticles needed to prepare a nanofluid containing a particular percentage by weight of CDC nanoparticles. For example, in various aspects, the prepared nanofluid may contain greater than zero and less than or equal to 0.3% by weight (wt %) of CDC nanoparticles. In some aspects, the prepared nanofluid may contain greater than or equal to 0.05 wt % and less than or equal to 0.3 wt % of CDC nanoparticles. In some aspects, the prepared nanofluid may contain 0.05, 0.1, or 0.3 wt % of CDC nanoparticles.

In some aspects of the example method 100, the predetermined amount of CDC nanoparticles may first be functionalized prior to being mixed in the base fluid. For example, the predetermined amount of the nanoparticles may be functionalized using a carboxylation process. In an example carboxylation process, CDC nanoparticle powder (e.g., 1 gram) may be dispersed in an acid mixture of sulfuric acid (H₂SO₄) (e.g., 60 mL) and phosphoric acid (H₃PO₄) (e.g., 40 mL) contained within a suitable container (e.g., a beaker), thereby forming a CDC-acid mixture. The beaker containing the acid mixture may be positioned in an ice bath, or other suitable cooling means, and the acid mixture may be continuously stirred while the CDC nanoparticle powder is dispersed in the acid mixture. In this example, the acid mixture has a volumetric ratio of H₂SO₄ to H₃PO₄ of 60:40. Potassium permanganate (KMnO₄) (e.g., 9 grams) may then be added to the CDC-acid mixture in the beaker, thereby forming a KMnO₄-CDC-acid mixture. In at least some aspects, the KMnO₄ is added slowly to the CDC-acid mixture. In at least some aspects, a temperature of the CDC-acid mixture may be maintained at or below 5° C. as the KMnO₄ is added.

The beaker containing the KMnO₄-CDC-acid mixture may then be transferred to an oil bath. In various aspects, the oil bath may be maintained at a temperature greater than or equal to 40° C. and less than or equal to 50° C. While positioned in the oil bath, the KMnO₄-CDC-acid mixture may be stirred for a predetermined amount of time (e.g., 2.5 hours). The beaker may then be moved back to the ice bath. In some instances, deionized water may be added (e.g., dropwise added) to the KMnO₄-CDC-acid mixture while it is positioned in the ice bath. For instance, adding the deionized water may help stabilize the reaction by helping avoid a temperature increase due to the highly exothermic nature of the reaction. In an example, 100 mL of deionized water may be added to the KMnO₄-CDC-acid mixture.

Once the reaction is stabilized, the beaker may be placed back in the oil bath. At this stage, the oil bath may be maintained at a temperature greater than or equal to 80° C. and less than or equal to 85° C. While positioned in the oil bath, the KMnO₄-CDC-acid mixture may be stirred for a predetermined amount of time (e.g., 2 hours). The beaker may then be moved back to the ice bath. With the beaker positioned in the ice bath, deionized water (e.g., 150 mL) and hydrogen peroxide (H₂O₂) (e.g., 20 mL) may be simultaneously and gradually added to the KMnO₄-CDC-acid mixture, thereby forming a reaction mixture. In at least some aspects, the reaction mixture may be stirred for a predetermined amount of time (e.g., 30 minutes) as the deionized water and hydrogen peroxide are added to the KMnO₄-CDC-acid mixture. At this stage, the reaction completion is inferred by a color change of the mixture from a brown chocolate color to a greenish-yellow solution.

In various aspects, the example carboxylation process may further include washing the reaction mixture to help remove acids and metal ions from the reaction mixture. For instance, the reaction mixture may be washed with hydrochloric acid (HCl). In one example, the reaction mixture may be washed with 10% HCl by volume in a volumetric ratio of 50:50 of the reaction mixture (e.g., 50 mL) and a diluted HCl solution (e.g., 50 mL). The acid washed reaction mixture may then be centrifuged, thereby obtaining wet oxidized CDC nanoparticle powder. In one example, the acid washed reaction mixture may be centrifuged at an agitation speed of 10,000 RPM for 15 minutes at room temperature. The wet oxidized CDC nanoparticle powder may then be washed and centrifuged one or more times to help remove acid residues until a neutral suspension having a pH of 7 is obtained. For instance, the wet oxidized CDC nanoparticle powder may be washed and centrifuged with deionized water. The obtained neutral suspension may then be dried. For example, the neutral suspension may be dried in an oven for 24 hours at a temperature of 75° C. The dried neutral suspension, or functionalized CDC nanoparticles, may then be mixed with the base fluid

In other aspects of the example method 100, rather than being functionalized, the predetermined amount of CDC nanoparticles may be mixed in the base fluid with a surfactant. Mixing the CDC nanoparticles with the surfactant emulsifies the CDC nanoparticles. In some examples, the surfactant may be gum Arabic, though in other examples, another suitable surfactant may be used. In some aspects, a ratio by weight of CDC nanoparticles to surfactant that are mixed is 1:1. In other aspects, a ratio by weight of CDC nanoparticles to surfactant that are mixed is 1:2. In other aspects still, the CDC nanoparticles and surfactant may be mixed at another suitable ratio by weight.

In various aspects of the example method 100, the mixture of the predetermined amount of CDC nanoparticles and the base fluid may be subjected to sonication (e.g., probe sonication) for a predetermined amount of time (block 104). Subjecting the mixture to sonication helps break the van der Waals forces between the carbon atoms of the CDC nanoparticles. In one example, the mixture is subjected to sonication for 45 minutes. In various aspects, the sonicator may be set with an amplitude of 65%, a pulse of 3:1, a frequency of 20 kHz, and a power of 500 W. Once the sonication is complete, the nanofluid is prepared.

### Experimental Validation

The inventors conducted various experiments to validate the properties of the provided nanofluid. It should be understood that no assertions are made as to which nanofluid composition demonstrated in the experiments is best or superior, or worse or inferior, compared to other nanofluid compositions demonstrated in the experiments or to other suitable nanofluid compositions provided by the present disclosure. Rather, the nanofluid compositions demonstrated in the following described experiments are merely examples of the provided nanofluid.

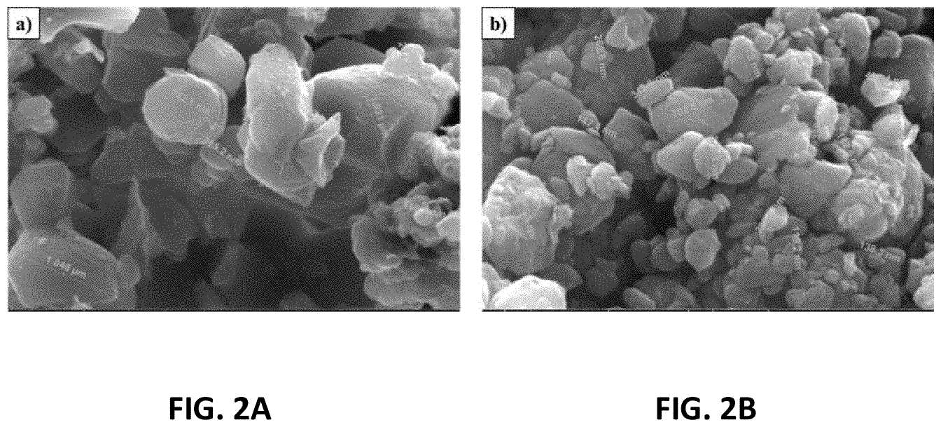

To study the morphology, shape and size of CDC particles prior to and post functionalization, SEM and TEM imaging were conducted. FIGS. 2A and 2B illustrate SEM images of raw and functionalized CDC nanoparticles respectively. The results indicate that there are no major changes occurring to the CDC throughout the functionalization process. Evidently, the CDC has an irregular and ununiformed spherical particles shapes with smooth surfaces. The CDC is seen to be agglomerated in some parts forming clusters, due to the chlorination process during the synthesis of CDC. Furthermore, the CDC has a wide range of particles sizes ranging between 100 nm to more than 1 μm.

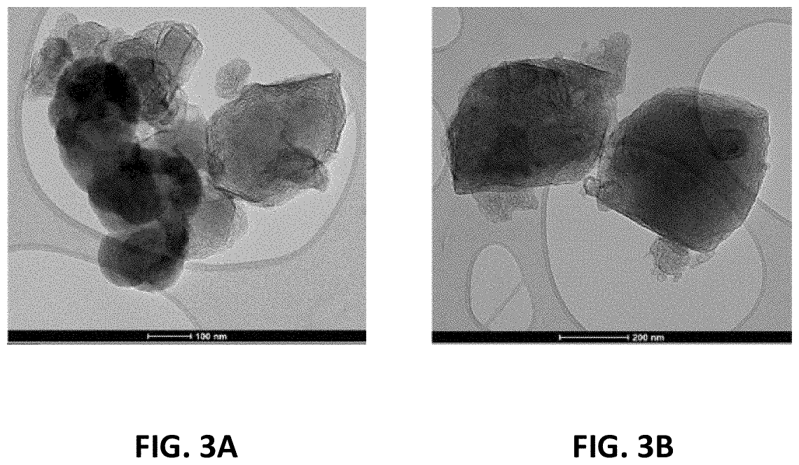

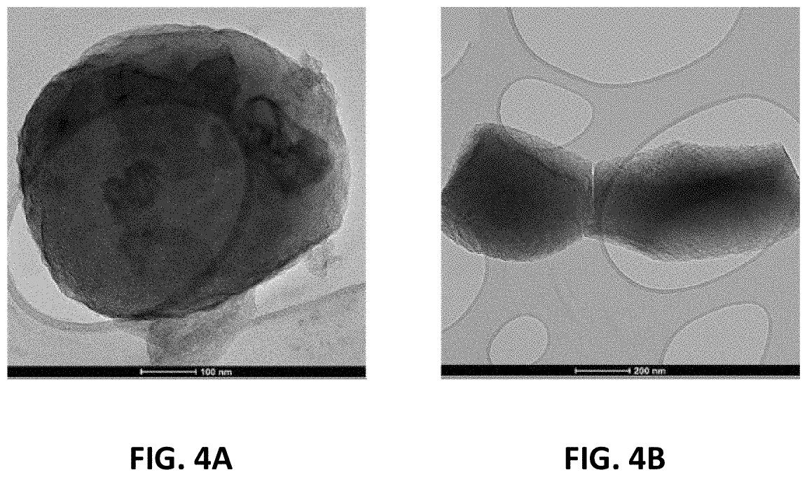

FIGS. 3A and 3B illustrate TEM images of raw CDC nanoparticles while FIGS. 4A and 4B illustrate TEM images of functionalized CDC nanoparticles. The illustrated TEM images indicate that the CDC has a highly microporous material. It can also be seen that the CDC began to form from the surface to the core of the carbide particles. This is confirmed by an amorphous carbon layer at the surface, with black dots at the centers representing the unconverted carbide. There were no observations or differences between the raw and functionalized CDC detected by the TEM.

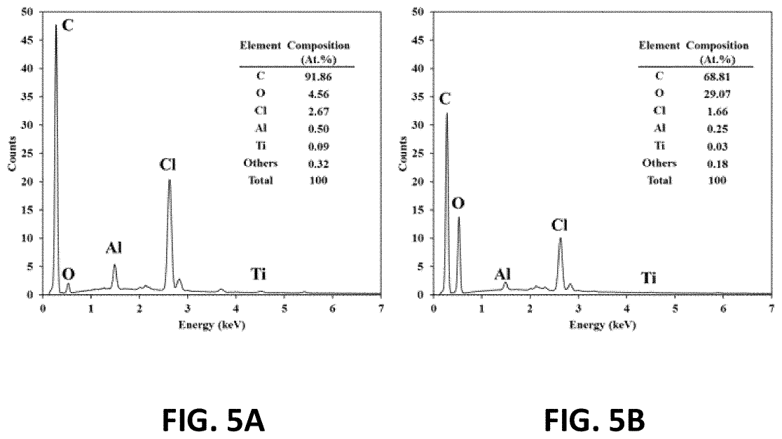

The elemental analysis of raw and functionalized CDC was conducted by energy-dispersive spectroscopy (EDS). FIGS. 5A and 5B illustrate EDS elemental analysis graphs of raw and functionalized carbide-derived carbon nanoparticles respectively. The atomic percentage of oxygen content increased from 4.56% for the raw CDC (FIG. 5A) to ˜29% for the functionalized CDC (FIG. 5B). The raw CDC had high carbon content confirming the conversion of the carbide; however, the titanium found in both of the samples confirmed the TEM analysis of the incomplete conversion of the carbide to carbon. The EDS analysis indicated the existence of chlorine due to the chlorination process and other impurities such as aluminum. The atomic percentages of chlorine, and impurities decreased due to the increasing oxygen content, and the immigration of these chemicals with the acid treatment process.

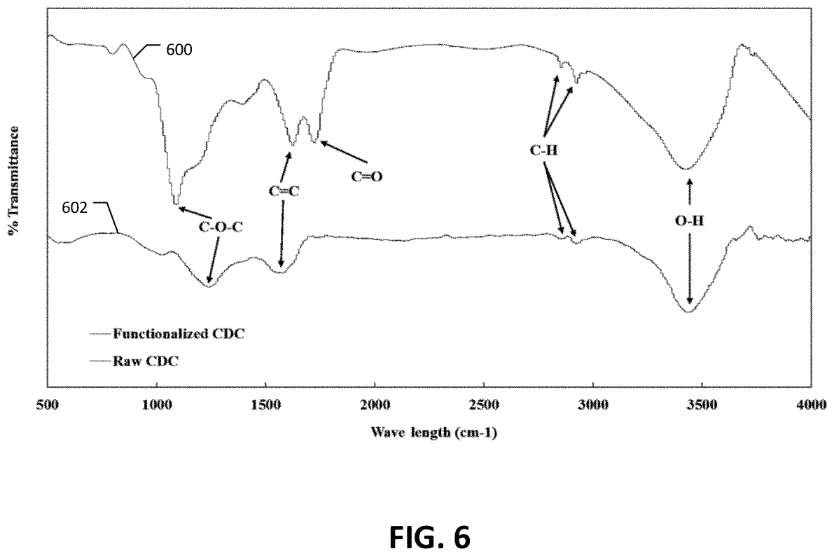

The developed functional groups on the surface of the CDC was determined by fourier-transform infrared spectroscopy (FTIR). FIG. 6 illustrates an FTIR spectrum graph of raw (line 602) and functionalized (line 600) carbide-derived carbon nanoparticles in a wavelength between 500 and 4000 cm⁻¹. According to the FTIR spectrum, the raw and functionalized CDC respectively demonstrated broad peaks at 3430 and 3421 cm⁻¹. These peaks referred to the O—H stretching which is believed to be a result of the ambient atmospheric moisture. Two more peaks were observed in both of the spectrums in a wavelength range of 2854 to 2925 cm⁻¹, respectively, which are attributed to the aliphatic stretches C—H on the surface of the CDC. Other bands at 1574 cm⁻¹ for raw CDC and at 1624 cm⁻¹ for functionalized CDC represent the aromatic C═C stretching groups. For the functionalized CDC, a new band appears at 1724 cm⁻¹ which is characteristic to the C═O stretching vibration of the carboxyl/carbonyl groups as a result of the functionalization process. The increase of the relative intensity of the band attributed to C—O—C bond as seen in the FIG. 6 suggests an increase of the oxygen content on the functionalized CDC. These observations confirm the successful surface functionalization of the CDC by acid treatment.

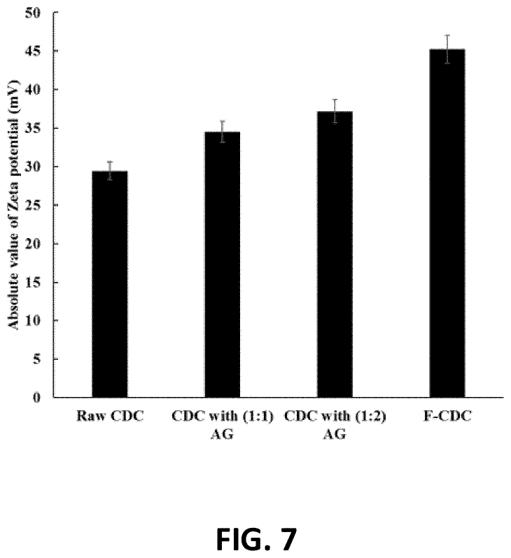

Dispersion and stability of nanoparticles is important in the study of nanofluids because of the possible aggregation of nanoparticles, and the effect of aggregation on thermal conductivity. Due to strong Van der Waals forces between carbon atoms, the agglomeration of particles with time reduces the stability of nanofluids and hence, collapses their thermal characteristics. The stability of the provided nanofluids was investigated by two methods, zeta potential analysis and sedimentation of CDC particles with time. FIG. 7 illustrates a graph of absolute values of Zeta potential measurements of CDC nanoparticles. The stability of nanoparticles have been categorized according to the zeta potential measurements by Vandsburger, L., Synthesis and covalent surface modification of carbon nanotubes for preparation of stabilized nanofluid suspensions. 2009, McGill University. The absolute value of the zeta potential value of raw CDC was 29.5 mV which is considered to be in the range of “little stability with settling to moderately stable”. CDC with gum Arabic ratios of 1:1 and 1:2 raised the absolute value of the zeta potential to 34.5 mV and 37.2 mV, respectively, which is in the range of “moderately stable to good stability with possible settling” according to the Vandsburger classification. For the functionalized CDC with oxygen, the absolute value of the zeta potential increased to 45.2 which is in the range of “good to excellent stability with little settling” according to the Vandsburger classification. The zeta potential measurements revealed that the prepared CDC nanofluids had homogeneous distribution and good stability of CDC.

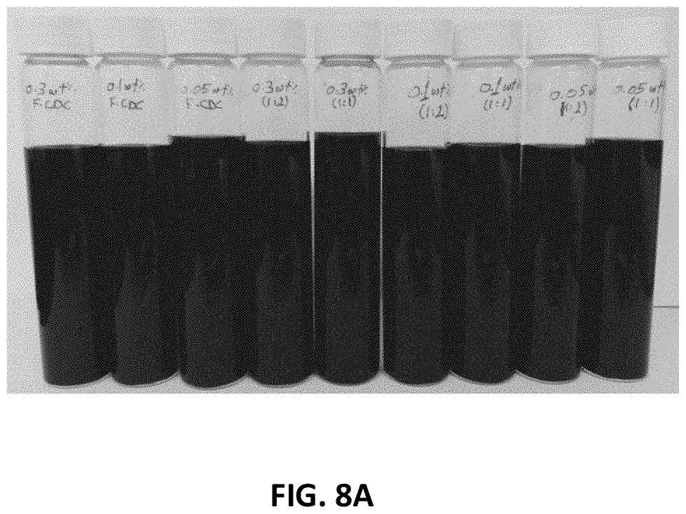

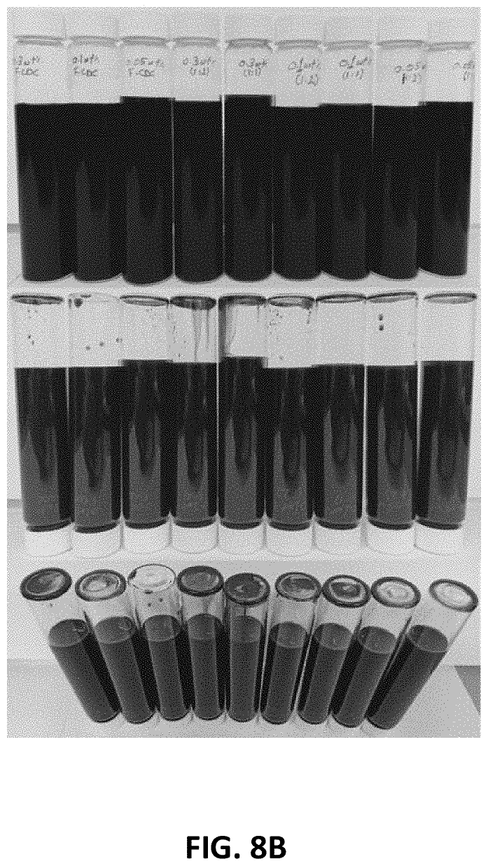

To confirm the stability of the provided CDC nanofluids, a digital photograph was observed for the CDC nanofluids at the preparation stage (FIG. 8A) and three months after preparation (FIG. 8B). Homogeneous and well dispersed CDC nanofluids were observed at the preparation stage as depicted in FIG. 8A. Three months after preparation, the nanofluids were found to be stable with agglomeration of some CDC particles as depicted in FIG. 8B. The agglomeration was most probably due to the existence of some big particles in the nanofluid. It was also observed that the amount of CDC sediment at the bottom of the vials increased with the loading of CDC. Moreover, the amount accumulated at the bottom was more for the emulsified CDC compared to the functionalized CDC nanofluids.

Rheology is a core parameter of nanofluids as it affects the pressure drop and pumping power requirements in real applications. The viscosity of nanofluids depends on the type, concentration and size of particles, and the type and concentration of surfactant used. The viscosity of nanofluids was investigated using a discovery hybrid rheometer (DHR). Nanofluids samples were injected by a syringe between a stationary plate and a moving cone gap geometries and allowed to be heated from 15-55° C. at a heat rate of 5° C./min. Viscosity is measured based on the torque between the fixed plate and moving cone. To ascertain the reproducibility and repeatability of the results, each run was measured three times, the maximum error was±5%.

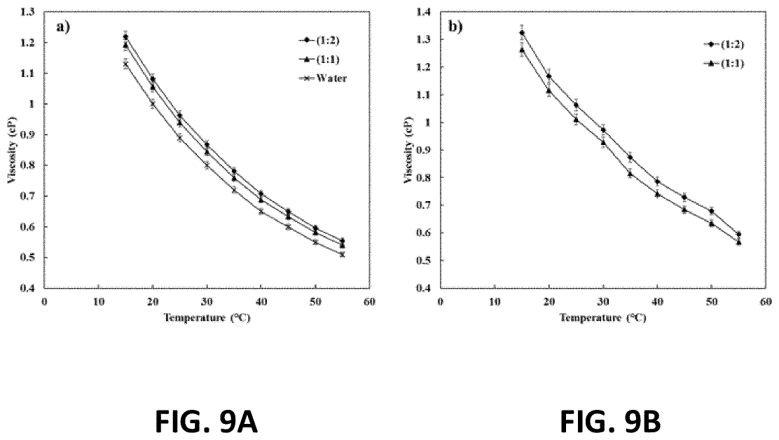

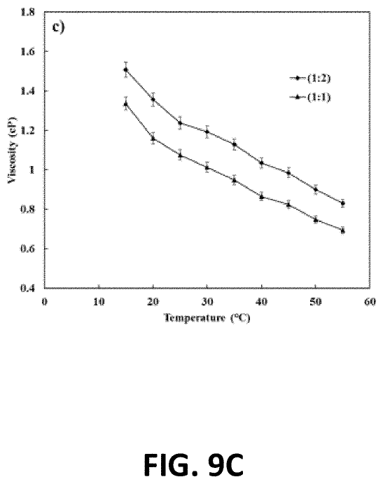

The viscosity of CDC-water nanofluids at different gum Arabic surfactant ratios and different CDC concentrations was investigated as a function of temperature, the results of which are illustrated in FIGS. 9A to 9C. FIG. 9A illustrates a viscosity graph for a nanofluid having 0.05% by weight (wt %) CDC, FIG. 9B for a nanofluid having 0.1 wt % CDC, and FIG. 9C for a nanofluid having 0.3 wt % CDC. As shown, the viscosity of the nanofluids increased with the concentration of CDC and surfactant ratio and decreased with temperature. For instance, at temperature of 15° C. and a surfactant ratio of 1:1, the relative increase in dynamic viscosity is 5.5%, 11.8% and 18.2% at CDC concentration of 0.05 wt %, 0.1 wt %, and 0.3 wt %, respectively. At the same temperature and CDC concentrations, doubling the loading of the gum Arabic to a surfactant ratio of 1:2 led to a dynamic viscosity increment increase of 7.9%, 17.2% and 33.4%, respectively.

The increase in viscosity of the CDC nanofluids can be explained by the introduction of a higher concentration of CDC particles and the emulsifier gum Arabic, which will increase the internal viscous shear stress and consequently increases the viscosity. Furthermore, the reduction in viscosity with temperature can be attributed to two main factors. First, due to the reduction in the attractive forces between CDC particles at elevated temperature. Second, the CDC particles gain more kinetic energy leading to an enhancement of the Brownian motion of the particles and thus decreasing its viscosity.

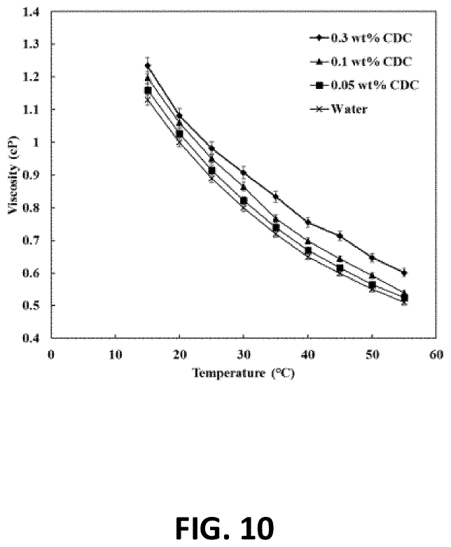

FIG. 10 illustrates a viscosity graph for nanofluids including functionalized CDC nanoparticles. As illustrated, the functionalized CDC nanofluids have lower viscosity measurements compared to nanofluids prepared with gum Arabic surfactant. For example, at a temperature of 20° C. the increase in dynamic viscosity was 2.8%, 6.0% and 8.1% at a concentration of functionalized CDC nanoparticles of 0.05 wt %, 0.1 wt % and 0.3 wt %, respectively. At the same temperature, the relative increase in viscosity measurements using a surfactant ratio of 1:1 was 5.5%, 11.6% and 16.0% at a CDC concentration of 0.0 5wt %, 0.1 wt % and 0.3 wt %, respectively. Considering the viscosity values, it can be observed that the gum Arabic doubled the viscosity of the nanofluids compared to the solutions prepared without the surfactant. As explained earlier, this is due to the addition of the surfactant effect which increases the internal viscous shear stress and accordingly increases the viscosity.

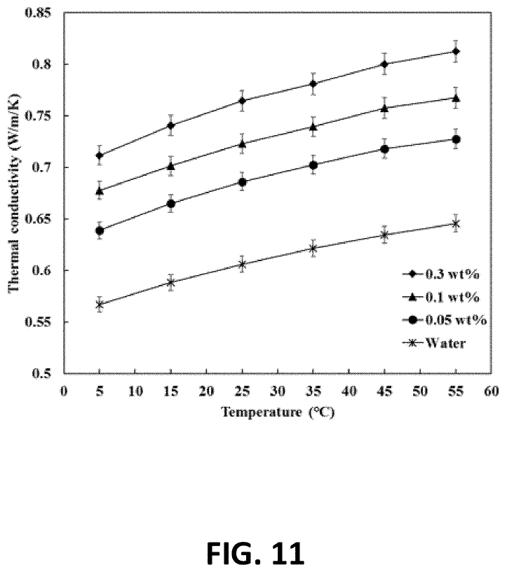

The thermal conductivity of CDC-water nanofluids was investigated using a thermal conductivity analyzer, that operates on the principle of the transient hot-wire method, within a temperature range of 5 to 55° C. at increments of 5° C. Each test run of temperature and thermal conductivity was collected 20 times and the average values were reported and displayed. FIG. 11 illustrates the thermal conductivity measurements of nanofluids including functionalized CDC nanoparticles at a temperature range between 5° C. and 55° C. at different CDC concentrations (0.05 wt %, 0.1 wt %, and 0.3 wt %). As shown, the thermal conductivity was enhanced with the increased concentration of functionalized CDC. For instance, at a temperature of 25° C. the thermal conductivity enhancement was 13.2%, 19.3% and 26.1% at a functionalized CDC concentration of 0.05 wt %, 0.1 wt %, and 0.3 wt %, respectively. It was observed that the percent enhancement in thermal conductivity at the same concentration of CDC in the used temperature range was consistent (e.g., the thermal conductivity enhancement at a functionalized CDC concentration of 0.3 wt % was 26%±1% within the investigated temperature range).

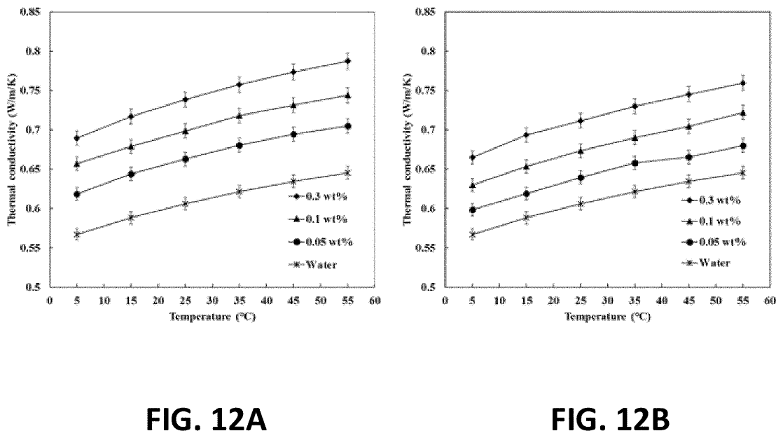

The effect of gum Arabic surfactant ratio on thermal conductivity of CDC nanofluids was also investigated and the results are illustrated in FIGS. 12A and 12B. It was observed that the enhancement in thermal conductivity of emulsified CDC nanofluids was lower than the enhancement of the functionalized CDC (without surfactant). Moreover, raising the surfactant ratio of gum Arabic from 1:1 to 1:2 has a negative impact on the thermal conductivity enhancement. For example, the enhancement in thermal conductivity at a temperature of 25° C. and CDC concentration of 0.3 wt %, was 26.1% for functionalized CDC, 21.8% for a gum Arabic ratio of 1:1, and 17.4% for a gum Arabic ratio of 1:2.

It can be concluded that the thermal conductivity enhancement depends onto two main factors: the addition of high thermal conductive materials to the base fluid and the stability of the particles. As illustrated from the thermal conductivity results, the surfactant ratio 1:2 has a higher stability compared to the ratio 1:1 and a lower thermal conductivity, which can be explained by the negative effect of the surfactant. However, the use of a 1:1 ratio produces a stable nanofluid with a thermal conductivity enhancement closer to the functionalized CDC nanofluid.

Specific heat capacity of nanofluids were measured by a modulated temperature differential scanning calorimeter (DSC) functionalized with a refrigerated cooling system. The measurement procedure was as follows. The nanofluid samples of (10-15 mg) were encapsulated in Tzero hermetic pans. The hermetic pans were weighed before and after encapsulation as the mass change is an input for DSC measurements. The samples were equilibrated for 1 min at 10° C., isolation for 3 min then allowed for heating from 10° C. to 60° C. with a heating rate of 3° C./min. All experiments were conducted under flowing nitrogen gas (50 ml/min). Heat capacity measurements were conducted three times to assure the repeatability and reproducibility of the results, where the maximum error was±4%. It was found that the heat capacity of nanofluids decreased with CDC concentration and slightly increased with temperature. The maximum reduction in specific heat capacity was 10.0% for the emulsified CDC nanofluids and 12.4% for the functionalized CDC nanofluids. The reduction in heat capacity is attributed to the suspension of lower heat capacity materials compared to the base fluid.

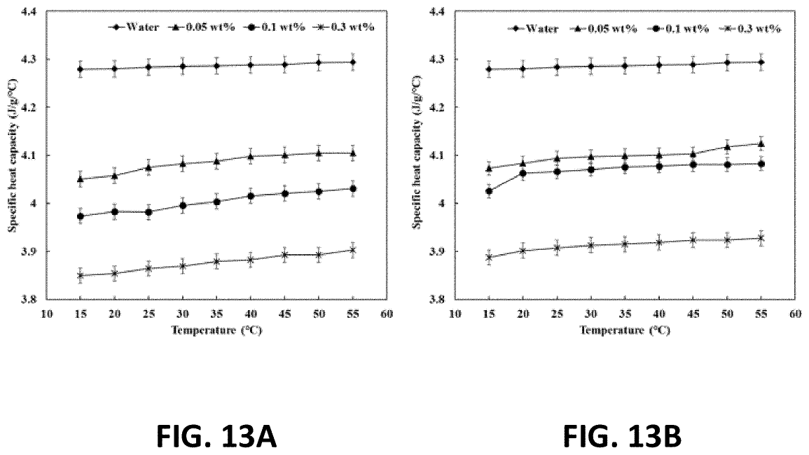

FIGS. 13A and 13B illustrate the specific heat capacity of nanofluids at a surfactant ratio of 1:1 and 1:2, respectively. As it can be seen, the surfactant ratio 1:2 demonstrated relatively higher specific heat capacities compared to the ratio 1:1. For example, the relative reduction in heat capacity at a temperature of 15° C. and surfactant ratio of 1:1 was 5.3%, 7.1%, and 10.0% using CDC intrusions of 0.05 wt %, 0.1 wt %, and 0.3 wt %, respectively, whereas at the same condition and using a surfactant ratio of 1:2, the heat capacity reduction was 4.8%, 5.9%, and 9.1% using CDC concentrations of 0.05 wt %, 0.1 wt %, and 0.3 wt %, respectively. While the increase in CDC concentration reduced the heat capacity, the addition of the surfactant was able to maintain the higher heat capacities of the nanofluids. This might be because the CDC is a carbon derivative material where the heat capacity is lower than that of water, though the addition of the surfactant enhances the distribution and stability of CDC particles in the water, thereby acting as a heat dipping into the CDC complex, which in turns allows them to store the heat before releasing into the base fluid.

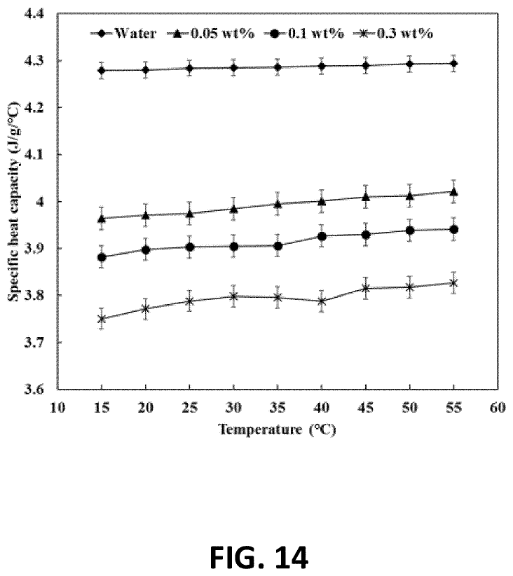

FIG. 14 illustrates the specific heat capacity of functionalized CDC nanofluids. It can be observed that the percent reduction in heat capacity of functionalized CDC nanofluids was higher than the reduction of the emulsified CDC nanofluids. For example, using 0.1 wt % of functionalized CDC and at temperature 20° C., the specific heat capacity reduction was 7.2%, while with emulsified CDC at the same temperature and using the gum Arabic ratio of 1:1, the reduction in heat capacity was 5.2%. The effect of surfactant on the specific heat capacity was opposite to its effect on thermal conductivity. For instance, while the addition of surfactant curtailed the effect of CDC on thermal conductivity of nanofluid, the addition of surfactant helped maintain the nanofluid's heat capacity.

As used herein, all numerical ranges should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

Without further elaboration, it is believed that one skilled in the art can use the preceding description to utilize the claimed inventions to their fullest extent. The examples and aspects disclosed herein are to be construed as merely illustrative and not a limitation of the scope of the present disclosure in any way. It will be apparent to those having skill in the art that changes may be made to the details of the above-described examples without departing from the underlying principles discussed. In other words, various modifications and improvements of the examples specifically disclosed in the description above are within the scope of the appended claims. For instance, any suitable combination of features of the various examples described is contemplated.

1. A method of preparing a nanofluid comprising:
mixing a predetermined amount of carbide-derived carbon nanoparticles in a base fluid, thereby forming a mixture; and
subjecting the mixture to sonication for a predetermined amount of time.

2. The method of claim 1, wherein the base fluid is water.

3. The method of claim 1, further comprising functionalizing the predetermined amount of carbide-derived carbon nanoparticles prior to mixing the functionalized predetermined amount of carbide-derived carbon nanoparticles in the base fluid.

4. The method of claim 3, wherein the predetermined amount of carbide derived carbon nanoparticles is functionalized with a carboxylation process.

5. The method of claim 4, wherein the carboxylation process includes:
dispersing carbide-derived carbon nanoparticle powder in an acid mixture of sulfuric acid (H₂SO₄) and phosphoric acid (H₃PO₄) thereby forming a CDC-acid mixture, wherein the acid mixture is positioned in an ice bath and continuously stirred while the carbide-derived carbon nanoparticle powder is dispersed in the acid mixture,
adding potassium permanganate (KMnO₄) to the CDC-acid mixture while maintaining a temperature of the CDC-acid mixture at or below 5° C. thereby forming a KMnO₄-CDC-acid mixture,
stirring the KMnO₄-CDC-acid mixture while the KMnO₄-CDC-acid mixture is positioned in an oil bath at a temperature greater than or equal to 40° C. and less than or equal to 50° C.,
adding deionized water to the KMnO₄-CDC-acid mixture while the KMnO₄-CDC-acid mixture is positioned in the ice bath,
stirring the KMnO₄-CDC-acid mixture while the KMnO₄-CDC-acid mixture is positioned in the oil bath at a temperature greater than or equal to 80° C. and less than or equal to 85° C., and
adding deionized water and hydrogen peroxide (H₂O₂) to the KMnO₄-CDC-acid mixture while the KMnO₄-CDC-acid mixture is positioned in the ice bath, thereby forming a reaction mixture.

6. The method of claim 5, wherein the acid mixture has a volumetric ratio of H₂SO₄ to H₃PO₄ of 60:40.

7. The method of claim 5, wherein the KMnO₄-CDC-acid mixture is stirred for 2.5 hours while positioned in the oil bath at a temperature greater than or equal to 40° C. and less than or equal to 50° C.

8. The method of claim 5, wherein the KMnO₄-CDC-acid mixture is stirred for 2 hours while positioned in the oil bath at a temperature greater than or equal to 80° C. and less than or equal to 85° C.

9. The method of claim 5, wherein the carboxylation process further includes:
washing the reaction mixture with hydrochloric acid (HCl),
subjecting the reaction mixture washed with HCl to centrifuge thereby obtaining wet oxidized carbide-derived carbon nanoparticle powder,
washing and subjecting to centrifuge the obtained wet oxidized carbide-derived carbon nanoparticle powder with deionized water until a neutral suspension having a pH of 7 is obtained, and
drying the obtained neutral suspension.

10. The method of claim 1, wherein the predetermined amount of carbide-derived carbon nanoparticles is mixed with a predetermined amount of a surfactant in the base fluid to thereby form the mixture.

11. The method of claim 10, wherein a ratio by weight of the predetermined amount of carbide-derived carbon nanoparticles to the predetermined amount of the surfactant is 1:1 or 1:2.

12. The method of claim 10, wherein the surfactant is gum Arabic.

13. A nanofluid comprising a base fluid and carbide-derived carbon nanoparticles suspended in the base fluid, wherein the carbide-derived carbon nanoparticles are one of functionalized or emulsified.

14. The nanofluid of claim 13, wherein the base fluid is water.

15. The nanofluid of claim 13, wherein a concentration of the carbide-derived carbon nanoparticles is greater than zero and less than or equal to 0.3% by weight of the nanofluid.

16. The nanofluid of claim 13, wherein a concentration of the carbide-derived carbon nanoparticles is equal to 0.3% by weight of the nanofluid.

17. The nanofluid of claim 13, further comprising a surfactant.

18. The nanofluid of claim 17, wherein a ratio by weight of carbide-derived carbon nanoparticles to surfactant is 1:1.

19. The nanofluid of claim 17, wherein a ratio by weight of carbide-derived carbon nanoparticles to surfactant is 1:2.

20. The nanofluid of claim 17, wherein the surfactant is gum Arabic.
